(19) United States
(12) Patent Application Publication
(10) Pub. No.: US 2021/0197116 A1
(43) Pub. Date: Jul. 1, 2021

(54) METHOD OF SCAVENGING ACID SULFIDE SPECIES

(71) Applicant: Innospec Limited, Ellesmere Port, Cheshire (GB)

(72) Inventor: Philip Maltas, Ellesmere Port, Cheshire (GB)

(73) Assignee: Innospec Limited, Ellesmere Port, Cheshire (GB)

(21) Appl. No.: 17/270,375

(22) PCT Filed: Aug. 21, 2019
(86) PCT No.: PCT/GB2019/052355

§ 371 Date: Feb. 22, 2021

(30) Foreign Application Priority Data
Aug. 22, 2018 (GB) 1813648.1

(51) Int. Cl. B01D 53/14; B01D 53/52; C02F 1/28; C02F 1/68; C10G 19/00; C10G 29/24

(52) U.S. Cl. CPC B01D 53/1468; C02F 2101/101; B01D 53/52; C02F 1/285; C02F 1/683; C10G 19/00; C10G 29/24; B01D 2259/124; B01D 2251/60; B01D 2251/80; B01D 2257/304; B01D 2252/504; B01D 2252/20436; C02F 2303/08; B01D 53/1493

(57) ABSTRACT

A method of scavenging acid sulfide species from an industrial or environmental material, the method comprising contacting the material with: (a) propenal and/or maleimide and/or ethyl-2-chloroacetoacetate; and (b) a base.

The present invention relates to methods for improving the scavenging of acidic sulfide species, especially hydrogen sulfide (H₂S). In particular the invention relates to scavenging hydrogen sulfide at a higher temperature and/or an increased rate.

Hydrogen sulfide and other acidic sulfide species are known to be formed within the oil and/or gas reservoir and thus they are an issue throughout the petroleum industry. They are an issue during the exploration, drilling, fracturing, completion, production, storage and transport of crude oil and natural gas. For example, crude oil, natural gas, produced water from within the well, used fracturing fluids, used water-flooding fluids and used drilling muds all may contain hydrogen sulfide.

Hydrogen sulfide and other acidic sulfide species are also problematic during the processing of crude oil and natural gas, where it is liberated by processes such as hydro-processing, cracking and coking. Furthermore, they are known to be present in liquids, distillation residues such as asphalt or bitumen and solids, such as coke, that are present in petroleum refineries. The acidic sulfide species may be present in petroleum refinery liquids such as liquid products, by-products, intermediates and waste streams.

Hydrogen sulfide and other acidic sulfide species are not just problematic for the petroleum industry. These compounds are also known to be present in waste waters, sewage, the effluent from tanneries and paper mills, geothermal fluids and thus geothermal power plants.

Hydrogen sulfide is highly toxic. It is very corrosive and can quickly damage machinery, storage tanks and pipelines. It is also poisonous to many catalysts.

It is therefore desirable to remove hydrogen sulfide and other acidic sulfide species from such materials, or at least reduce the levels present. Various methods of removing hydrogen sulfide and other acidic sulfide species are known. One such method is the use of hydrogen sulfide scavengers, which react selectively with hydrogen sulfide in an attempt to remove it from the material.

The removal of hydrogen sulfide from crude oil or natural gas may occur at various points during the production and processing operations. For example, the hydrogen sulfide may be removed from within the wellbore or during above ground processing, such as during the storage and/or transportation of crude oil or natural gas. The hydrogen sulfide scavengers may also be used during the refining process.

A number of hydrogen sulfide scavengers are currently used in industry. These may be based on organic compounds, bases, metal oxides, metal chelates or oxidising agents. Examples of commonly used organic hydrogen sulfide scavengers include aldehydes and protected aldehydes such as acetals, and nitrogen based scavengers such as amines, triazines and imine compounds. For example US2018/0030360 describes the use of compounds of formula (I):

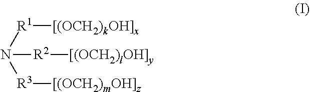

in combination with Michael acceptors as scavengers and antifoulants. One or more of x, y or z may be 0 and one or two of R¹, R² and R³ may be hydrogen.

Metal oxides, metal chelates and oxidising agents are known to react with hydrogen sulfide to form adducts with high thermal stability. However, such adducts are often insoluble solids which may cause blockage during production. Some oxidising scavengers also result in the formation of SOT species, which may cause corrosion and pipeline damage or solid sulfur deposits which can cause blockages.

Some organic hydrogen sulfide scavengers form adducts that are unstable at higher temperatures, often re-releasing hydrogen sulfide gas when heated. Some organic hydrogen sulfide scavengers have slow reaction rates meaning long contact times are needed.

This can be an issue, for example, when scavengers are used in pipelines at low temperatures and the product is later heated, for example in a refinery. This subsequent heating can cause toxic, corrosive sulfide species such as hydrogen sulfide to be re-released.

For example, in scheme 1 monoethanolamine triazine (MEA triazine) forms adduct(s) when reacted with hydrogen sulfide, for example dithanes:

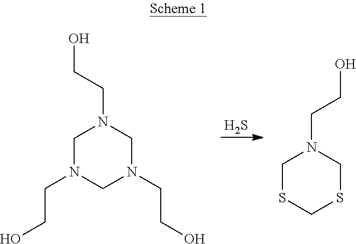

However, heating (for example to temperatures in excess of 100° C.) can lead to the degradation of some or all of the adducts causing hydrogen sulfide gas to be re-released.

There is therefore a need to improve the thermal stability and/or reaction rate of organic hydrogen sulfide scavengers, as well as avoiding the formation of precipitates and corrosive by-products.

According to a first aspect of the present invention there is provided a method of scavenging acid sulfide species from an industrial or environmental material, the method comprising contacting the material with:
(a) propenal and/or maleimide and/or ethyl-2-chloroacetoacetate; and
(b) a base.

The present invention relates to a method of scavenging an acidic sulfide species.

By scavenging acidic sulfide species we mean to refer to the removal or reduction of the amount of acidic sulfide species present in the industrial or environmental material.

By acidic sulfide species we mean to refer to any compound including a sulfur atom having a −2 oxidation state bound to an acidic hydrogen atom or the conjugate base thereof. The conjugate base refers to the anion formed on removal of the acidic hydrogen atom.

Suitable acidic sulfide species include H₂S; compounds containing the ions HS⁻ or S²⁻; and any compound or ion containing the functional groups —SH, —S⁻, —S—SH, —S—S⁻, —SₙH, —S₍ₙ₋₁₎S⁻.

Suitable acidic sulfide species include hydrogen sulfide (H₂S) or its anion (HS), sulfide anion (S²⁻); thiols (RSH) and their conjugate base (RS⁻); hydrodisulfides (R—S—S—H) and their conjugate base (R—S—S⁻); or hydropolysulfides (RSₙH) and their conjugate base (RSₙ₋₁S⁻). R may be, for example, an optionally substituted alkyl, alkenyl, aryl, aralkyl, alkaryl or heterocyclic group. However it will be appreciated that the specific nature of the R group is unimportant since it is the sulfur containing functional group that is scavenged.

Preferably the acidic sulfide species is selected from hydrogen sulfide (H₂S), sulfide anion (S²⁻); hydrosulfide ion (HS⁻); compounds including a thiol group (—SH) and their conjugate base (—S⁻).

Preferably the present invention relates to the scavenging of hydrogen sulfide or a source thereof in an industrial or environmental material. By hydrogen sulfide or a source thereof we mean to refer to hydrogen sulfide or a compound which readily generates hydrogen sulfide. Compounds which generate hydrogen sulfide include the thiol, disulfide and polysulfide species mentioned above.

Suitably the present invention relates to a method of scavenging hydrogen sulfide from an industrial or environmental material.

The industrial or environmental material may include solids, liquids or gasses that are obtained from any industries or environments where hydrogen sulfide may be present.

The industrial material may be a product, by-product, intermediate or waste stream obtained from an industry and may be solid or a fluid, such as liquid or a gas. For example, the industrial material may be sourced from an oil well, a petroleum refinery, the cargo hold of a vehicle transporting crude oil or petroleum products, an oil pipeline, a farm slurry pit, sewage works, paper mill or tannery.

The industrial or environmental material may be selected from fluids in or extracted from an oil well; products, by-products, intermediates and waste streams from refineries and other industries; water; sewage; and geothermal fluids.

Fluids in or extracted from an oil well may be selected from: crude oil; gas condensate; gas; sour gas; produced water; drilling fluids; fracturing fluids and water flooding fluids.

The drilling fluids and fracturing fluids may preferably be selected from drilling fluids in use, used drilling fluids, fracturing fluids in use and used fracturing fluids.

The products, by-products, intermediates and waste streams from refineries and other industries may be solids or fluids such as liquids or gases.

Other industries may be selected from biofuel production, farming, tanneries, paper mills and power.

In one embodiment, the industrial or environmental material may be selected from: gas condensate; gas; drilling fluids in use; used drilling fluids; fracturing fluids in use; used fracturing fluids; solid products, by-products, intermediates and waste streams from refineries; fluid products, by-products, intermediates and waste streams from refineries; and solid and liquid products, by-products, intermediates and waste streams from other industries such as biofuel production, farming, tanneries, paper mills and power.

In a preferred embodiment, the industrial or environmental material is selected from crude oil, produced water, petroleum refinery liquids, coke, asphalt or bitumen, used fracturing fluids, used water-flooding fluids, brines, geothermal fluids or sour gas.

The present invention may provide a method of scavenging acidic sulfide species, for example hydrogen sulfide, from crude oil.

In one preferred embodiment the industrial or environmental material comprises crude oil.

One particular advantage of the present invention is that it can be used to scavenge acidic sulfide species, for example hydrogen sulfide, from water containing materials and aqueous based systems, for example brines.

In one embodiment the industrial or environmental material suitably comprises water. In some embodiments it may comprise at least 30 wt % water, for example at least 50 wt % water, at least 70 wt % water or at least 90 wt % water.

Brines and other aqueous media are commonly used or produced in crude oil recovery and treatment processes and in other industrial applications.

In the method of the present invention the industrial or environmental material is contacted with (a) propenal and/or maleimide and/or ethyl-2-chloroacetoacetate; and (b) a base.

Component (a) comprises one or more compounds selected from propenal, maleimide and ethyl-2-chloroacetoacetate.

In some embodiments the first aspect may involve contacting an industrial or environmental material with (a) propenal and/or maleimide; and (b) a base.

In some embodiments component (a) comprises propenal.

In some embodiments component (a) comprises maleimide.

In some embodiments component (a) comprises ethyl-2-chloroacetoacetate.

In some embodiments component (a) comprises propenal and maleimide.

In some embodiments component (a) comprises propenal and ethyl-2-chloroacetoacetate.

In some embodiments component (a) comprises maleimide and ethyl-2-chloroacetoacetate.

In some embodiments component (a) comprises propenal, maleimide and ethyl-2-chloroacetoacetate.

Propenal is also commonly known as acrolein and has the structure shown in figure (II):

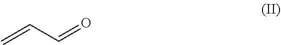

Maleimide has the structure shown in figure (III):

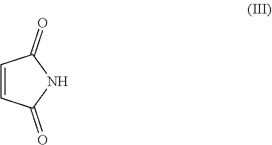

Ethyl-2-chloroacetoacetate has the structure shown in figure (IV):

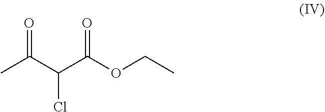

Preferably component (a) comprises propenal.

Component (b) comprises a base. Any suitable base may be used.

Suitable bases include organic bases and inorganic bases.

Preferably component (b) is selected from:

(i) amino compounds;
(ii) phosphorus containing bases; and
(iii) inorganic bases.

In some embodiments component (b) comprises (i) an amino compound.

Suitable amino compounds for use herein include aliphatic amines and aromatic amines. Suitable amino compounds include monoamines and polyamines.

The amino compound may include one or more primary, secondary or tertiary amine groups.

The amino compound may have the formula RNH₂, R₂NH or R₃N wherein in each case each R group is independently an optionally substituted alkyl, alkenyl, aryl, alkaryl or aralkyl group.

In some embodiments each R group is an unsubstituted alkyl, alkenyl, aryl, alkaryl or aralkyl group.

When R is a substituted alkyl, alkenyl, aryl, alkaryl or aralkyl group, preferred substituents are amino, alkyl amino, alkoxy and hydroxy. R may include a cyclic group.

Suitably each R group is independently an alkyl, alkenyl or aryl having 1 to 20, preferably 1 to 10, suitably 1 to 4 carbon atoms.

In some embodiments two or three R groups may together form a cyclic, bicyclic or tricyclic amine. This may provide one or more aliphatic or aromatic heterocyclic moieties.

Such aliphatic or aromatic heterocycles may further comprise one or more additional heteroatoms, such as sulfur or especially oxygen.

In some embodiments the amino compound may comprise more than one amino functional group.

In some embodiments the amino compound may be a triazine compound, especially an aliphatic triazine compound.

In some embodiments the amino compound may include one or more further non-amino functional groups.

In some embodiments the amino compound may be an oxazolidine compound, especially a bisoxazolidine.

In some embodiments component (b) comprises an amine of formula R¹R²R³N in which each of R¹, R² and R³ is independently selected from hydrogen or an optionally substituted alkyl, alkenyl, aryl, alkaryl or aralkyl group. Suitably at least one of R¹, R² and R³ is not hydrogen.

Each of R¹, R² and R³ may include a cyclic moiety and two or three of the groups R¹, R² and R³ may be joined to form one or more cyclic groups.

In some preferred embodiments R¹ is hydrogen or an optionally substituted alkyl or aralkyl group; R² is hydrogen or an optionally substituted alkyl or aralkyl group; and R³ is an optionally substituted alkyl group or aralkyl group.

For the avoidance of doubt the term aralkyl is used to refer to an aryl substituted alkyl group.

In some preferred embodiments component (b) comprises an amine of formula R¹R²R³N in which each of R¹, R² and R³ is independently selected from hydrogen or an alkyl group which is optionally substituted with a group selected from hydroxy, alkoxy, amino, alkylamino, dialkylamino or aryl, provided that at least one of R¹, R² and R³ is not hydrogen.

In some embodiments none of R¹, R² and R³ is hydrogen and the amino compound is a tertiary amine.

In some embodiments one of R¹, R² and R³ is hydrogen and the amine is a secondary amine.

In some embodiments two of R¹, R² and R³ are hydrogen and the amine is a primary amine.

In some embodiments component (b) may comprise an amine compound of formula (I):

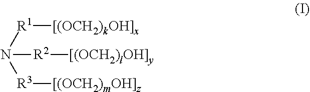

in which R¹, R² and R³ is hydrogen or an optionally substituted alkylenyl, alkenylenyl, alkynylenyl, alkyl, alkenyl or alkaryl group, each of k, l and m is 0 to 25 provided at least one is not 0; x is 0 or 1, y is 0 or 1; z is 0 or 1 and x+y+z is 1, 2 or 3. Compounds of this type are disclosed in US2018/0030360.

Preferably component (b) does not comprise a compound of formula (I).

In some embodiments component (b) comprises an amine of formula R¹R²R³N in which each of R¹, R² and R³ may be an alkyl group which is optionally substituted with a group selected from hydroxy, alkoxy, amino, dialkyl amino or aryl.

Each of R¹, R² and R³ may be an unsubstituted alkyl group. Such groups may be straight chain or branched, or cyclic.

In some embodiments each of R¹, R² and R³ may be a hydroxy substituted alkyl group. Preferably the hydroxy substituent is at a terminal position. Suitable hydroxy substituted alkyl groups (hydroxyalkyl groups) include those of formula HO(CH₂)ₙ wherein n is at least 1. Other groups including branching and more than one terminal hydroxy group are also within the scope of the invention.

In some embodiments each of R¹, R² and R³ may be an alkoxy substituted alkyl group, for example of formula CH₃(CH₂)ₘO(CH₂)ₙ wherein n is at least 1 and m may be 0 or a positive integer. Branched isomers are also within the scope of the invention.

In some embodiments each of R¹, R² and R³ may be an amino substituted alkyl group, for example a group of formula NH₂(CH₂)ₙ wherein n is at least 1.

In some embodiments each of R¹, R² and R³ may be an alkyl amino or dialkyl amino substituted alkyl group, for example a group of R′NH(CH₂)ₙ or R′R″N(CH₂)ₙ wherein n is at least one and R′ and R″ are each alkyl groups.

In some embodiments each of R¹, R² or R³ may be aryl substituted alkyl group for example Ar—(CH₂)ₙ wherein n is at least one and Ar is an aryl group, for example an optionally substituted phenyl group.

In some embodiments each of R¹, R² and R³ may comprise a cyclic moiety. The cyclic moiety may include one or more heteroatoms. Suitable cyclic moieties include cyclohexyl, morpholino and piperazinyl groups.

In some embodiments each of R¹, R² and R³ may include an alkoxylated moiety of formula HO(R′O)ₙR″ in which each of R′ and R″ is an alkylene group and n is at least one. Suitably each of R′ and R″ has 1 to 12, preferably 1 to 6, suitably 1 to 4 carbon atoms. R′ and R″ may be the same or different. When n is greater than 1, each R′ may be the same or different.

Thus in some embodiments component (b) may comprise an alkoxylated amine, for example an ethoxylated and/or propoxylated amine.

In some embodiments component (b) may comprise a polyamine. By polyamine we mean to refer to any compound including two or more amino functional groups. Each of the two or more functional groups may independently be primary, secondary or tertiary amino groups. The polyamine may be a cyclic polyamine. Suitable diamines include piperazine and derivatives thereof, and dimethylaminopropylamine. Other suitable polyamines include polyalkylene polyamines, for example polyethylene polyamines. The skilled person will appreciate that commercial sources of polyalkylene polyamines, for example polyethylene polyamines, will typically comprise a mixture of compounds, for example different homologues and/or different isomers.

Suitably each of groups R¹, R² and R³ has 1 to 12 carbon atoms, for example 1 to 6 carbon atoms.

In some preferred embodiments component (b) comprises an amino compound selected from alkylamines, alkanolamines, alkoxyalkyl amines and mixtures thereof. Amines which include a mixture of alkyl and/or hydroxyalkyl and/or alkoxyalkyl substituents also fall within this class of compounds. In some embodiments the amino compound is of formula R¹R²R³N, wherein each of R¹, R² and R³ is independently selected from hydrogen, an alkyl group, a hydroxyalkyl group or an alkoxyalkyl group, provided that at least of R¹, R² and R³ is hydrogen. Suitably each of R¹, R² and R³ is independently selected from hydrogen and an alkyl, hydroxyalkyl or alkoxyalkyl group having 1 to 20 carbon atoms, preferably 1 to 12 carbon atoms, more preferably 1 to 6 carbon atoms, for example 1 to 4 carbon atoms. Each alkyl, hydroxyalkyl or alkoxyalkyl may be straight chain or branched. In some embodiments R¹, R² and R³ may be a cyclic group. Straight chain groups are preferred. Each of R¹, R² and R³ may be the same or different.

Suitably each of R¹, R² and R³ is independently selected from hydrogen and an alkyl, hydroxyalkyl or alkoxyalkyl group. Each of R¹, R² and R³ may be independently selected from hydrogen, methyl, ethyl, propyl, butyl, pentyl, hexyl, hydroxymethyl, hydroxyethyl, hydroxypropyl, hydroxybutyl, hydroxypentyl, hydroxyhexyl, methoxymethyl, methoxylethyl, methoxypropyl, methoxybutyl, methoxypentyl, methoxyhexyl, ethoxymethyl, ethoxyethyl, ethoxypropyl, ethoxybutyl, ethoxypentyl, ethoxyhexyl, propoxymethyl, propoxyethyl, propoxypropyl, propoxybutyl, propoxypentyl, propoxyhexyl, butoxymethyl, butoxyethyl, butoxypropyl, butoxybutyl, butoxypentyl, butoxyhexyl and isomers thereof. Suitable isomers include, for example cyclohexyl and isopropyl.

In some embodiments the amino compound may be selected from an alkylamine, a hydroxyalkylamine, a dialkylamine, a hydroxyalkyl alkyl amine, a dihydroxyalkylamine, a trialkylamine, a dialkylhydroxyalkylamine, a dihydroxyalkylalkylamine or a trihydroxyalkylamine. There are many different compounds of this type and these will be known to the person skilled in the art. In some embodiments the amine may be a cyclic amine.

Preferred amino compounds of formula R¹R²R³N include monoethanolamine, triethylamine, methoxypropylamine, cyclohexylamine, triethanolamine, 3-phenylpropylamine, diethanolamine, 2-aminopropylamine, tributylamine, N-(2-hydroxyethyl)ethylenediamine, N¹,N¹-bis(2-aminoethyl)-1,2-ethanediamine, 1-(2-aminoethyl)piperazine, 4-(2-aminoethyl)phenol, 2-amino-2-(hydroxymethyl)propane-1,3-diol, 4-(2-aminoethyl)morpholine, 2-(2-aminoethoxy)ethanol, dimethylaminopropylamine, ethylene diamine and 1,8-diazabicyclo(5.4.0)undec-7-ene (DBU).

Especially preferred amino compounds of formula R¹R²R³N include monoethanolamine, methoxypropylamine, triethylamine and monomethylamine.

In some embodiments component (b) comprises a triazine. As those skilled in the art will appreciate, in the field of the present invention the term triazine is used to refer to the condensation product of 3 primary amine molecules and 3 aldehyde molecules.

The triazine may be optionally substituted on at least one of the nitrogen atoms.

Suitably the triazine is a compound having an aliphatic core of formula (V):

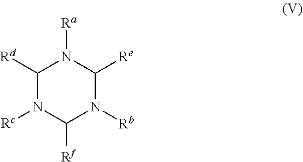

wherein each of R^{a}, R^{b}, R^{c}, R^{d}, R^{e} and R^{f} is independently selected from hydrogen or an optionally substituted hydrocarbyl group.

R^{d}, R^{e} and R^{f} may each be the same or different. Preferably R^{d}, R^{e} and R^{f} are the same.

Preferably each of R^{d}, R^{e} and R^{f} is hydrogen or an optionally substituted alkyl or aryl group.

Preferred alkyl and aryl groups have 1 to 20 carbon atoms, preferably 1 to 10 carbon atoms, more preferably 1 to 4 carbon atoms.

Preferably each of R^{d}, R^{e} and R^{f} is hydrogen or an unsubstituted alkyl group.

Preferably each of R^{d}, R^{e} and R^{f} is hydrogen.

R^{a}, R^{b} and R^{c} may each be the same or different. Preferably R^{a}, R^{b} and R^{c} are the same.

Preferably each of R^{a}, R^{b} and R^{c} is an optionally substituted alkyl, alkenyl, aryl, alkaryl or aralkyl group.

Preferably each of R^{a}, R^{b} and R^{c} has 1 to 20 carbon atoms, preferably 1 to 10 carbon atoms, more preferably 1 to 4 carbon atoms.

Preferably each of R^{a}, R^{b} and R^{c} is an optionally substituted alkyl group.

Preferably each of R^{a}, R^{b} and R^{c} is an unsubstituted alkyl group or a hydroxy-substituted alkyl group.

Preferably each of R^{a}, R^{b} and R^{c} is an alkyl group or a hydroxyalkyl group having 1 to 10, preferably 1 to 6, more preferably 1 to 4 carbon atoms.

Suitably each of R^{a}, R^{b} and R^{c} is hydroxyethyl, methoxypropyl or methyl.

In one preferred embodiment each of R^{a}, R^{b} and R^{c} is hydroxyethyl.

In some preferred embodiments the triazine is monoethanolamine (MEA) triazine.

In some preferred embodiments the triazine is monomethylamine (MMA) triazine.

In some preferred embodiments the triazine is methoxypropylamine (MOPA) triazine.

In some embodiments component (b) comprises an oxazolidine compound. Preferred oxazoline compounds are bisoxazolidine compounds of formula (VI):

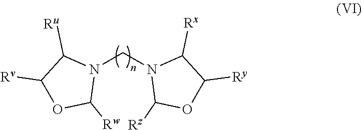

wherein n is at least 1 and each of R^{u}, R^{v}, R^{w}, R^{x}, R^{y} and R^{z} is independently hydrogen or an optionally substituted alkyl, alkenyl, aryl, alkaryl or aralkyl group.

Preferably each of R^{u}, R^{v}, R^{w}, R^{x}, R^{y} and R^{z} is hydrogen or an optionally substituted alkyl group.

Preferably each of R^{u}, R^{v}, R^{w}, R^{x}, R^{y} and R^{z} is hydrogen or an unsubstituted alkyl group, suitably having 1 to 12 carbon atoms.

Preferably each of R^{u}, R^{w}, R^{x} and R^{z} is hydrogen and R^{v} and R^{y} is each a Cᵢ to C₄ alkyl group.

Preferably R^{v} is methyl and R^{y} is methyl.

n is suitably 1 to 6, preferably 1 to 4. Most preferably n is 1.

One especially preferred compound of formula (V) for use herein is methylene bis(5-methyloxazolidine).

Preferably when component (b) comprises an amino compound, this is selected from triazines, bisoxazolidines, alkylamines, alkanolamines, alkoxyalkyl amines and mixtures thereof.

Suitably when component (b) comprises amino compound this may be selected from triazines, oxazolidines, polyamines and amines of formula R¹R²R³N in which each of R¹, R² and R³ is independently selected from hydrogen, alkyl or hydroxyalkyl.

When component (b) comprises one or more amino compounds these are preferably selected from monoethanolamine triazine (MEA triazine), monomethylamine triazine (MMA triazine), methoxypropylamine triazine (MOPA triazine), methylene bis(5-methyloxazolidine), monoethanolamine, triethylamine, methoxypropylamine, cyclohexylamine, triethanolamine, 3-phenylpropylamine, diethanolamine, 2-aminopropylamine, tributylamine, N-(2-hydroxyethyl)ethylenediamine, N¹,N¹-bis(2-aminoethyl)-1,2-ethanediamine, 1-(2-aminoethyl)piperazine, 4-(2-aminoethyl)phenol, 2-amino-2-(hydroxymethyl)propane-1,3-diol, 4-(2-aminoethyl)morpholine, 2-(2-aminoethoxy)ethanol, dimethylaminopropylamine, ethylene diamine and 1,8-diazabicyclo(5.4.0)undec-7-ene (DBU).

Preferred amino compounds (i) include one or more of MEA triazine, MMA triazine, MOPA triazine, monoethanolamine, methoxypropylamine, triethylamine, 2-aminoethoxyethanol, methylene bis(5-methyloxazolidine) and N-(2-hydroxyethyl) ethylene diamine.

More preferred amino compounds (i) include one or more of MEA triazine, MMA triazine, MOPA triazine, monoethanolamine, methoxypropylamine, triethylamine, 2-aminoethoxyethanol and methylene bis(5-methyloxazolidine).

Most preferred amino compounds (i) are one or more of MEA triazine, MMA triazine, MOPA triazine, monoethanolamine, methoxypropylamine, triethylamine, 2-aminoethoxyethanol and N-(2-hydroxyethyl) ethylene diamine.

MEA triazine is especially preferred.

In some embodiments component (b) comprises (ii) a phosphorus containing base. Suitable phosphorus containing bases include phosphines PR₃. Any phosphorous compound including a nucleophilic electron pair may be used. Suitably each R is independently an optionally substituted alkyl, alkenyl, aryl, alkaryl or aralkyl moiety.

Preferably each R is independently selected from an optionally substituted alkyl or aryl group having 1 to 20, preferably 1 to 12, more preferably 1 to 8, for example 1 to 6 carbon atoms.

Each R group may be the same or different.

Preferably each R group is the same.

Preferably each R group is an unsubstituted alkyl group, preferably an unsubstituted C1 to C4 alkyl group.

Most preferably each R is methyl.

Preferred phosphorus containing bases are phosphines.

In one embodiment component (b) comprises trimethyl phosphine.

In some embodiments component (b) comprises an inorganic base. Suitable inorganic bases will be known to the person skilled in the art and include alkali metal, alkaline earth metal and ammonium hydroxides, oxides, carbonates and bicarbonates.

Preferred inorganic bases are alkali metal, alkaline earth metal or ammonium hydroxides. Alkali metal and ammonium hydroxides are especially preferred.

Suitable inorganic bases include potassium hydroxide, lithium hydroxide and sodium hydroxide.

One especially preferred inorganic base is sodium hydroxide.

Component (b) may comprise a mixture of two or more bases.

In some embodiments component (b) comprises one or more amino compounds and one or more phosphorous containing bases.

In some embodiments component (b) comprises one or more amino compounds and one or more inorganic bases.

In some embodiments component (b) comprises one or more phosphorous containing bases and one or more inorganic bases.

In some embodiments component (b) comprises one or more amino compounds, one or more phosphorous containing bases and one or more inorganic bases.

Preferably component (b) comprises (i) one or more amino compounds.

Preferably component (b) comprises a base selected from one or more of: an amino compound selected from triazines, oxazolidines, polyamines and amines of formula R¹R²R³N in which each of R¹, R² and R³ is independently selected from hydrogen or an optionally substituted hydrocarbyl group; phosphorous containing bases; and inorganic bases.

Suitably component (b) comprises a base selected from one or more of:
a triazine of formula (V):

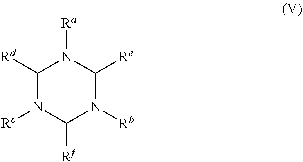

in which each of R^{a}, R^{b}, R^{c}, R^{d}, R^{e} and R^{f} is hydrogen or an optionally substituted hydrocarbyl group;
a bisoxazolidine of formula (VI):

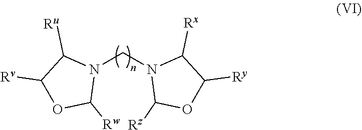

wherein n is at least 1 and each of R^{u}, R^{v}, R^{w}, R^{x}, R^{y} and R^{z} is independently hydrogen or an optionally substituted alkyl, alkenyl, aryl, alkaryl or aralkyl group;
an amine of formula R¹R²R³N in which each of R¹, R² and R³ is independently hydrogen or an optionally substituted alkyl, alkenyl, aryl, alkaryl or aralkyl group, provided that at least one of R¹, R² and R³ is not hydrogen;
a phosphine; and
an alkali metal or ammonium hydroxide.

Preferably component (b) comprises a base selected from one or more of:
a triazine of formula (VA):

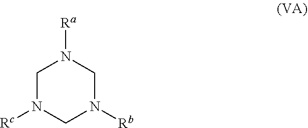

in which each of R^{a}, R^{b} and R^{c} is an alkyl, hydroxyalkyl or alkoxyalkyl group;
methylene bis(5-methyloxazolidine);
an amine of formula R¹R²R³N in which each of R¹, R² and R³ is independently hydrogen or an alkyl group which is optionally substituted with a group selected from hydroxy, alkoxy, amino, alkylamino, dialkylamino or aryl, provided that at least one of R¹, R² and R³ is not hydrogen;
a trialkyl phosphine; and
an alkali metal or ammonium hydroxide.

Preferably component (b) comprises a base selected from one or more of:
a triazine of formula (VA):

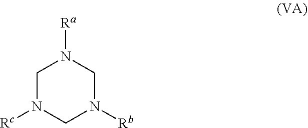

in which each of R^{a}, R^{b} and R^{c} is an alkyl or hydroxyalkyl group having 1 to 10, preferably 1 to 4 carbon atoms;
methylene bis(5-methyloxazolidine);
an amine of formula R¹R²R³N in which each of R¹, R² and R³ is hydrogen or an alkyl, hydroxyalkyl or alkoxyalkyl having 1 to 10, preferably 1 to 4 carbon atoms, provided that at least one of R¹, R² and R³ is not hydrogen;
trimethyl phosphine; and
sodium hydroxide.

In preferred embodiments the present invention involves the combination of (a) propenal and/or maleimide and/or ethyl-2-chloroacetoacetate and (b) an amino compound selected from triazines, methylene bis(5-methyloxazolidine), alkylamines, alkanolamines and alkoxyalkylamines.

In the method of the present invention component (a) and component (b) may be added to the industrial or environmental material in a single composition or they may be provided in separate compositions. Preferably they are provided in separate compositions.

When component (a), propenal and/or maleimide and/or ethyl-2-chloroacetoacetate, and component (b), a base, are contacted with each other they suitably form one or more reaction products. Depending on the conditions at which they are contacted, the reaction product(s) may either be in the form of a liquid or a solid.

Thus in embodiments in which component (a) and component (b) are added to the industrial or environmental material in a single composition the conditions are suitably selected to prevent or reduce the formation of solid reaction product(s). Preferably in such embodiments the propenal and/or maleimide and/or ethyl-2-chloroacetoacetate (a) and the base (b) are mixed at 0° C. to form the single composition. When a single composition is used, it is preferably rapidly contacted with the industrial or environmental fluid as the performance may decrease with time.

Preferably component (a) and component (b) are provided in separate compositions.

Suitably the amounts of (a) propenal and/or maleimide and/or ethyl-2-chloroacetoacetate and (b) base added to the industrial or environmental material is dependent on various factors, for example the amount of acidic sulfide species, for example hydrogen sulfide, present in the material; the desired final level of acidic sulfide species in the material; the nature of the base; the reaction time needed to achieve the desired level of acidic sulfide species and the temperature of the environmental or industrial material.

The selection of appropriate conditions will be within the competence of the person skilled in the art.

Suitably the propenal and/or maleimide and/or ethyl-2-chloroacetoacetate may be contacted with the industrial or environmental material before the base is contacted with the industrial or environmental material. Alternatively the propenal and/or maleimide and/or ethyl-2-chloroacetoacetate may be contacted with the industrial or environmental material after the base is contacted with the industrial or environmental material.

Preferably the industrial or environmental material is contacted concurrently with a composition comprising propenal and/or maleimide and a composition comprising a base.

The method of the first aspect preferably involves adding a first composition comprising propenal and/or maleimide and/or ethyl-2-chloroacetoacetate and a second separate composition comprising a base. Suitably the first and second compositions are added separately and concurrently to the industrial or environmental material.

Suitably the amount of (a) propenal and/or maleimide and/or ethyl-2-chloroacetoacetate and (b) base used in the method of the first aspect is determined based on the estimated concentration of acidic sulfide species present in the industrial or environmental material.

In preferred embodiments from 0.1 to 20 molar equivalents of (a) propenal and/or maleimide and/or ethyl-2-chloroacetoacetate is added to industrial or environmental material per mole of acidic sulfide species, preferably from 0.5 to 10 molar equivalents.

In preferred embodiments from 0.1 to 20 molar equivalent of (b) base is added to industrial or environmental material per molar of acidic sulfide species, preferably from 0.5 to 10 molar equivalents.

Suitably the molar ratio of (a) propenal and/or maleimide and/or ethyl-2-chloroacetoacetate to (b) base is from 10:1 to 1:100, preferably from 5:1 to 1:50, for example from 2:1 to 1:10.

In some embodiments the first composition comprising propenal and/or maleimide and the second composition comprising the base are admixed with the industrial or environmental material in an amount of from 0.1 ppm to 10000 ppm, preferably in an amount of from 10 ppm to 1000 ppm.

In some embodiments the propenal and/or maleimide and/or ethyl-2-chloroacetoacetate is provided in an aqueous composition and/or the base is provided in an aqueous composition.

In some embodiments the first composition comprising (a) propenal and/or maleimide and/or ethyl-2-chloroacetoacetate further comprises a solvent. Suitable solvents include organic solvents and aqueous solvents.

The first composition may comprise a mixture of two or more solvents.

Suitable organic solvents include aromatic and aliphatic solvents, including oxygenated solvents and halogenated solvents.

In some embodiments water is the major solvent present in the first composition. In some embodiments water provides for at least 50 wt % of all solvents present in the composition, preferably at least 60 wt %, more preferably at least 70 wt %, suitably at least 80 wt %, for example at least 90 wt % or at least 95 wt %. In some embodiments one or more further water miscible solvents may be present. Examples of suitable water miscible solvents include monohydric and polyhydric alcohols, for example ethanol, glycerol, isopropanol, methanol, diethylene glycol, propylene glycol and polyethylene glycol.

In some embodiments, for example when component (a) comprises maleimide and/or ethyl-2-chloroacetoacetate, an organic solvent may be the major solvent present in the first composition. Suitable organic solvents include methyl ethyl ketone, acetone, toluene, ethyl acetate, xylene, dimethylformaldehyde, methyl isobutyl ketone, mixed aromatic solvents (such as those sold under the trade mark Caromax) and mixtures thereof.

Suitably the propenal and/or maleimide and/or ethyl-2-chloroacetoacetate is present in the first composition in an amount of from 1 to 100 wt %, preferably 5 to 100 wt %, for example 10 to 100 wt %.

The second composition comprising (b) the base may comprise a mixture of two or more such compounds.

In some embodiments the second composition further comprises a solvent. Suitable solvents include organic solvents and aqueous solvents.

The second composition may comprise a mixture of two or more solvents.

Suitable organic solvents include aromatic and aliphatic solvents, including oxygenated solvents and halogenated solvents.

Suitably water is the major solvent present in the second composition. In some embodiments water provides for at least 50 wt % of all solvents present in the composition, preferably at least 60 wt %, more preferably at least 70 wt %, suitably at least 80 wt %, for example at least 90 wt % or at least 95 wt %. In some embodiments one or more further water miscible solvents may be present. Examples of suitable water miscible solvents include monohydric and polyhydric alcohols, for example ethanol, glycerol, isopropanol, methanol, diethylene glycol, propylene glycol and polyethylene glycol.

Suitably the base is present in the second composition in an amount of from 1 to 100 wt %, preferably 5 to 100 wt %, for example 10 to 100 wt %.

The first and second compositions may each further comprise one or more further components. In some embodiments a scale inhibitor may be present in the first composition and/or in the second composition. Suitable scale inhibitors are known to those skilled in the art.

In some embodiments a corrosion inhibitor may be present in the first composition and/or in the second composition. Suitable corrosion inhibitors are known to those skilled in the art.

The first and second compositions may each further comprise one or more further components selected from biocides, friction reducers, drag reducing agents, surfactants, foaming agents, carbon dioxide scavengers, oxygen scavengers and metal scavengers.

According to a second aspect of the present invention there is provided a product for scavenging acid sulfide species, the product comprising:
(a) a first composition propenal and/or maleimide and/or ethyl-2-chloroacetoacetate; and
(b) a second composition comprising a base.

In some embodiments the product of the second aspect may further comprise (c) a scale inhibitor and/or a corrosion inhibitor.

In some embodiments the product of the second aspect may further comprise means for delivering the first composition comprising (a) propenal and/or maleimide and/or ethyl-2-chloroacetoacetate and/or means for delivering the second composition comprising the base to the industrial or environmental material. Suitable means will be known to the person skilled in the art and include, for example injection means.

The first and/or second compositions may be injected via injection quills. In some preferred embodiments a continuous injection pump with a higher number of strokes per minute can be used. Suitable means of monitoring the quantity and/or injection rate of the compositions would also be used.

According to a third aspect of the present invention there is provided the use of the combination of (a) propenal and/or maleimide and/or ethyl-2-chloroacetoacetate; and (b) a base to scavenge an acidic sulfide species, for example hydrogen sulfide.

Preferred features of the second and third aspects of the present invention are as defined in relation to the first aspect.

It has been surprisingly found that the claimed combination of (a) propenal and/or maleimide and/or ethyl-2-chloroacetoacetate and (b) a base is more effective at scavenging acidic sulfic species, for example hydrogen sulfide than when either component is used alone.

Advantageously the claimed combination of (a) propenal and/or maleimide and/or ethyl-2-chloroacetoacetate and (b) a base scavenges and retains acidic sulfic species, for example hydrogen sulfide at a higher temperature and/or an increased rate compared to when a base, for example an amino compound, alone is used.

By scavenging acidic sulfide species we mean to refer to the removal or reduction of the amount of acidic sulfide species present in a material. By retains acidic sulfide species we mean that the acid sulfide species are not readily re-released.

One problem of the prior art is that some hydrogen sulfide scavengers re-release hydrogen sulfide at high temperatures, for example at temperatures greater than 100° C.

The claimed combination of component (a) and component (b) may scavenge and retain acidic sulfide species, for example hydrogen sulfide at higher temperatures relative to the temperature at which the base, for example an amino compound scavenges and retains the acidic sulfide species when it is used alone.

Suitably the combination of (a) propenal and/or maleimide and/or ethyl-2-chloroacetoacetate and (b) a base scavenges and retains acid sulfide species for example hydrogen sulfide at temperatures of at least 140° C. Preferably the combination scavenges and retains acidic sulfate species, for example hydrogen sulfide at temperatures of at least 150° C. In some embodiments, for example when component for example when component (a) comprises propenal and/or maleimide the combination scavenges and retains acidic sulfate species, for example hydrogen sulfide, at temperatures of at least 160° C. or 170° C. In some especially preferred embodiments the amino compound scavenges and retains acidic sulfide species, for example hydrogen sulfide at temperatures of at least 180° C.

Thus the present invention suitably provides the use of (a) propenal and/or maleimide and/or ethyl-2-chloroacetoacetate and (b) a base to scavenge and retain acidic sulfide species at temperatures of at least 140° C., for example at least 180° C. Suitably the acidic sulfide species is retained at temperatures of at least 140° C., for example at least 180° C. for at least 10 minutes. The acidic sulfide species (for example hydrogen sulfide) may be retained at temperatures of at least 140° C. for at least 20 minutes or at least 30 minutes.

The use of (a) propenal and/or maleimide and/or ethyl-2-chloroacetoacetate and (b) a base may increase the rate at which acid sulfide species are scavenged.

By the rate at which an acidic sulfide compound is scavenged and retained we mean to refer to the change in concentration of the acidic sulfide species over time. The increase in rate is relative to the rate at which the amino compound scavenges an acidic sulfide species when used alone.

Suitably the use of the combination of (a) propenal and/or maleimide and/or ethyl-2-chloroacetoacetate and (b) a base scavenges and retains the acid sulfide species present in an industrial or environmental material at an increased rate under identical conditions of temperature and concentration than would be achieved using the amino compound alone. Suitably the time period to reduce the acidic sulfide species concentration by the same amount at the same temperature using the combination is less than half the time period when using the amino compound alone.

The present invention may provide the use of the combination of (a) propenal and/or maleimide and/or ethyl-2-chloroacetoacetate and (b) a base to scavenge and retain acidic sulfide species, for example hydrogen sulfide, from an aqueous based industrial or environmental fluid at a higher temperature and/or an increased rate compared to using the amino compound alone.

Typically the industrial or environmental material may comprise up to 1000 mg of hydrogen sulfide per litre (L) of material. In some embodiments, the industrial or environmental material contains up to 500 mg/L, or for example up to 200 mg/L of hydrogen sulfide. It may contain up to 150 mg/L or 100 mg/L of hydrogen sulfide. For example, the industrial or environmental material may contain 0.1 to 100 mg/L or 0.01 to 100 mg/L of hydrogen sulfide.

A further advantage of some embodiments of the present invention is that the combination of (a) propenal and/or maleimide and/or ethyl-2-chloroacetoacetate and (b) a base may reduce the formation of precipitates compared to the use of the base compared alone.

For some bases, particularly amine bases, especially when used at low concentrations, precipitates can occur following contact with an industrial or environmental material to scavenge acidic sulfide species.

It has advantageously been found that the formation of precipitates is reduced when using a combination of (a) propenal and/or maleimide and/or ethyl-2-chloroacetoacetate and (b) a base according to the present invention.

Thus the present invention may further provide the use of the combination of (a) propenal and/or maleimide and/or ethyl-2-chloroacetoacetate and (b) a base to scavenge acidic sulfide species wherein the formation of precipitates in the resultant composition is reduced compared to an equivalent system in which only an amino compound is used.

Ethyl-2-chloroacetoacetate has been found to be particularly effective at reducing precipitate formation.

The invention will now be further described with reference to the following non-limiting examples.

### EXAMPLE 1

The thermal stability of various combinations of propenal and/or maleimide (a) and a base (b) as hydrogen sulfide scavengers was tested according to the following procedure:

2 ml of a stock solution containing 0.6 mg/ml of Na₂S in water was added to water (8 ml) in a reaction vessel with stirrer bar. The vessel was tightly sealed and hydrogen sulfide was generated in situ by injecting HCl (0.07 ml of 0.5M solution, 2 molar equivalents relative to Na₂S). Thus the solution contained approximately 50 mg/I of hydrogen sulfide. 5 molar equivalents relative to Na₂S of propenal or maleimide or ethyl-2-chloroacetoacetate (a) and 5 molar equivalents relative to Na₂S of a base (b) were then injected and the mixture heated to 75° C. for 30 minutes with stirring. After cooling to room temperature the scavenged mixture was poured into a transparent pressure vessel. An H₂S indicator was placed inside the pressure vessel (not touching the liquid) and the system sealed. The pressure vessel was then heated (5° C. per minute) to a maximum temperature of 180° C. or until the indicator showed the presence of H₂S in the gas phase. Results are shown in Table 1.

Examples 1 to 12 are of the invention. Example 13 is comparative.

TABLE 1

| | | Propenal/ | | |
|---|---|---|---|---|
| | | maleimide/ | | Temperature |
| | | ethyl-2- | | at which |
| Ex- | | chloroaceto- | | H₂S is |
| mple | Base | acetate | Solvent | re-released |
| 1 | MEAtriazine | None | Water | 100° C. |
| 2 | None | Propenal | Water | Does not fully |
| | | | | scavenge after 30 |
| | | | | minutes |
| 3 | MEAtriazine | Propenal | Water | >180° C. |
| 4 | MEAtriazine | Maleimide | Water | 170° C. |
| 5 | Monoethanolamine | None | Water | Does not fully |
| | | | | scavenge afer 30 |
| | | | | minutes |
| 6 | Monoethanolamine | Propenal | Water | >180° C. |
| 7 | Monoethanolamine | Maleimide | Water | >180° C. |
| 8 | Triethylamine | Propenal | Water | >180° C. |
| 9 | Triethylamine | Maleimide | Water | 155° C. |
| 10 | PMe₃ | Propenal | Water | >180° C. |
| 11 | NaOH | Propenal | Water | >180° C. |
| 12 | MEAtriazine | ethyl-2- | water | 150° C. |
| | | chloroaceto- | | |
| | | acetate | | |
| 13 | MEAtriazine | glyoxal | water | 95° C. |

### EXAMPLE 2

The thermal stability of a variety of amines in combination with propenal was tested according to the procedure of Example 1. The results are provided in Table 2:

TABLE 2

| | | | Tempera- |
|---|---|---|---|
| | | | ture at |
| | | | which |
| Exam- | | | H₂S is |
| ple | Amine | Media | released |
| 14 | None | Water | Did not |
| | | | scavenge |
| | | | (sulfides |
| | | | remains) |
| 15 | 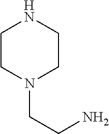 | Water | 180° C. |
| 16 | 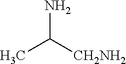 | Water | 180 ° C. |
| 17 | 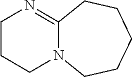 [SMILES: C1CCC2=NCCCN2CC1] | Water | >180° C. |
| 18 | 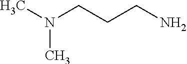 | Water | 180° C. |
| 19 | 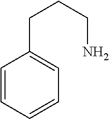 | Water | 180° C. |
| 20 | 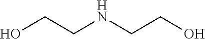 | Water | 180° C. |
| 21 | 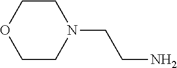 | Water | 180° C. |
| 22 | 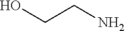 | Water | 180° C. |
| 23 | 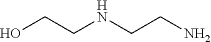 | Water | 180° C. |
| 24 | 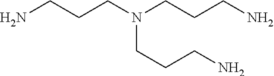 [SMILES: NCCCN(CCCN)CCCN] | Water | >180° C. |
| 25 | 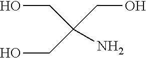 | Water | >180° C. |
| 26 | 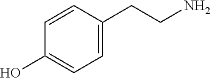 | Water | 180° C. |
| 27 | 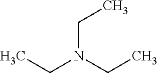 | Water | >180° C. |
| 28 | 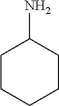 | Water | 180° C. |
| 29 | 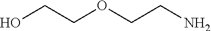 | Water | >180° C. |
| 30 | 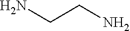 | Water | 180° C. |

### EXAMPLE 3

A combination of MEA triazine and propenal or MEA triazine and ethyl-2-chloroacetoacetate was incubated for 30 minutes at 75° C. in a variety of brines using a procedure analogous to that described in Example 1. The temperature at which hydrogen sulfide is re-released was measured.

The results are shown in Table 3.

TABLE 3

| | | | Temperature at |
|---|---|---|---|
| | Scavenger | Brine (% | which H₂S is |
| Example | COmbination | dissolved salt) | re-released |
| 1B | MEA triazine | Deionised water | 100° C. |
| 2B | MEA triazine and | Deionised water | >180° C. |
| 2B | Pro penal | Deionised water | >180° C. |
| 3B | MEA triazine and | Bakken (25%) | >180° C. |
| | Propenal | | |
| 4B | MEA triazine and | IOC (11%) | >180° C. |
| | Propenal | | |
| 5B | MEA triazine and | Marcellus (8%) | >180° C. |
| | Propenal | | |
| 6B | MEA triazine and | Eagle Ford (2%) | >180° C. |
| | Propenal | | |
| 7B | MEA triazine and ethyl- | Deionised water | 150° C. |
| | 2-chloroacetoacetate | | |
| 8B | MEA triazine and ethyl- | Bakken (25%) | 150° C. |
| | 2-chloroacetoacetate | | |
| 9B | MEA triazine and ethyl- | IOC (11%) | 150° C. |
| | 2-chloroacetoacetate | | |
| 10B | MEA triazine and ethyl- | Marcellus (8%) | 150° C. |
| | 2-chloroacetoacetate | | |
| 11B | MEA triazine and ethyl- | Eagel Ford (2%) | 150° C. |
| | 2-chloroacetoacetate | | |

### EXAMPLE 4

The rate at which compounds and combinations of compounds scavenge hydrogen sulfide was measured as follows:

2 ml of a stock solution containing 0.6 mg/ml of Na₂S in water was added to water (18 ml) in a reaction vessel with stirrer bar. The vessel was tightly sealed and hydrogen sulfide was generated in situ by injecting HCl (0.07 ml of 0.5M solution, 2 molar equivalents relative to Na₂S). Thus the solution contained approximately 25 mg/I of hydrogen sulfide. The mixture was heated to 30° C. with stirring and an aliquot (0.3 ml) was removed via syringe and the liquid-phase H₂S content determined using a colourimetric test. This is the time=0 reading. 5 molar equivalents relative to Na₂S of propenal or maleimide (a) and 5 molar equivalents relative to Na₂S of a base (b) were then injected and the scavenging monitored by testing aliquots of the mixture at set time intervals (typically 1, 5, 10 and 20 minutes).

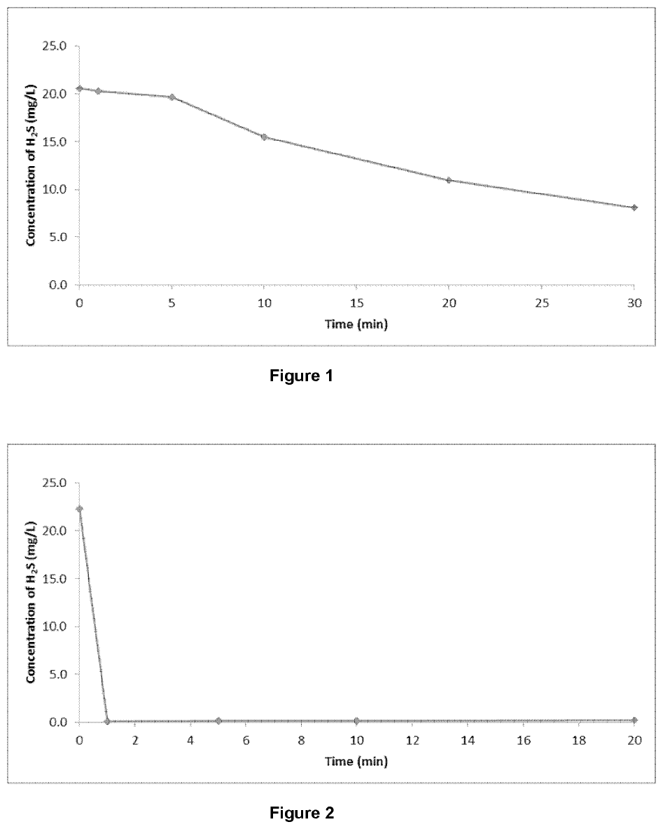

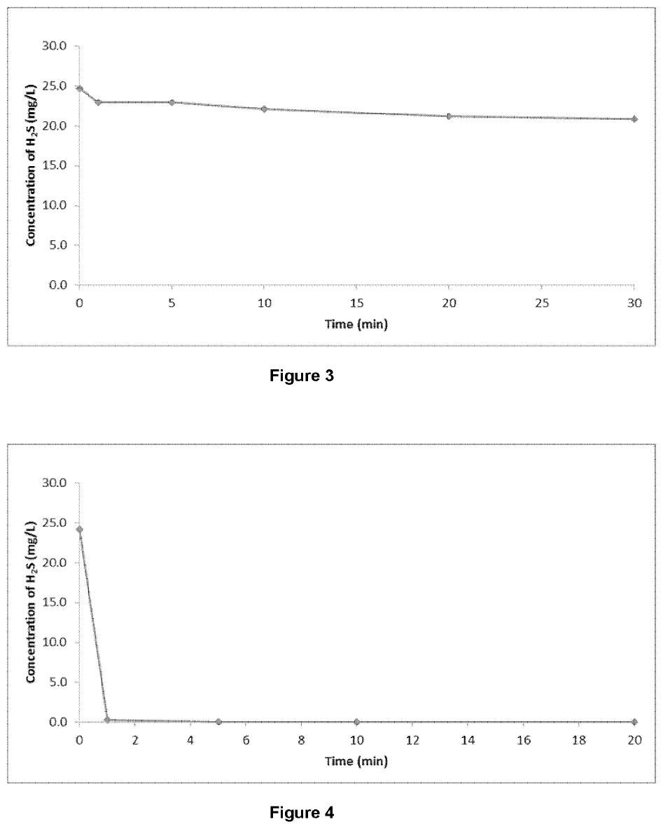

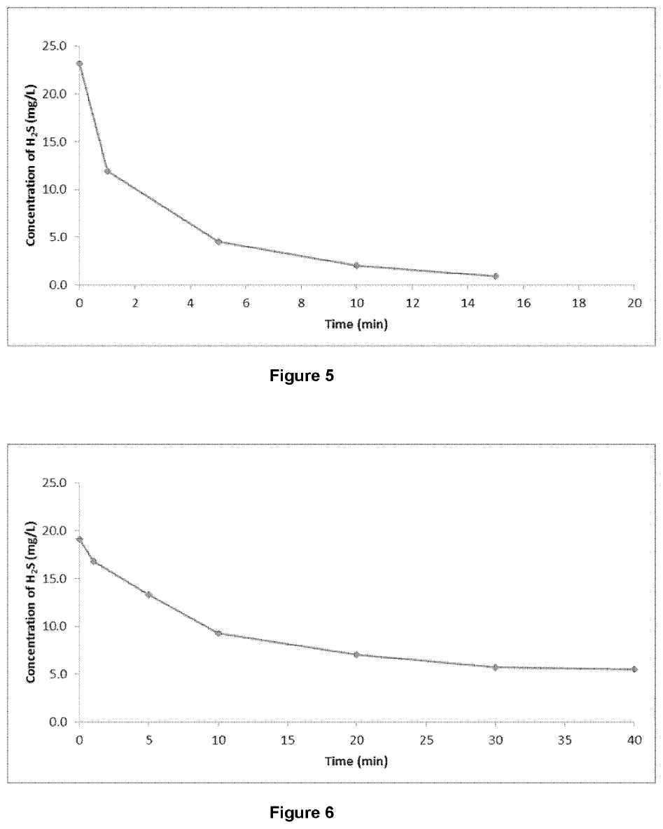

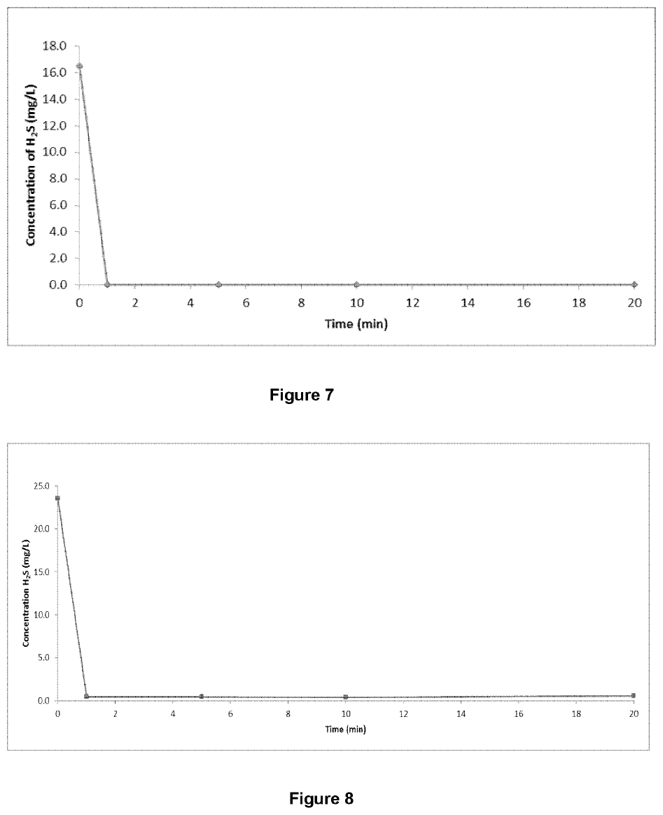

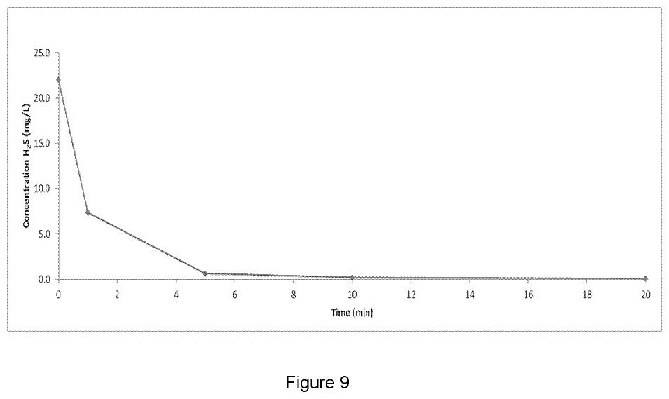

Table 4 and FIG. 1 to show how the rate of combination of acrolein and MEA triazine scavenge hydrogen sulfide at much greater rate than MEA triazine alone.

TABLE 4

| | | Average concentration of H₂S (mg/L) after period of: | | | | | | | |
|---|---|---|---|---|---|---|---|---|---|
| Component | | 0 | 1 | 5 | 10 | 15 | 20 | 30 | FIG. |
| (b) | Component (a) | min | min | min | min | min | min | min | number |
| MEA triazine | none | 20.6 | 20.3 | 19.7 | 15.5 | | 10.9 | 8.1 | 1 |
| MEA triazine | maleimide | 22.3 | 0.1 | 0.2 | 0.2 | | 0.2 | | 2 |
| None | propenal | 24.7 | 22.9 | 22.9 | 22.1 | | 21.2 | 20.9 | 3 |
| MEA triazine | propenal | 24.2 | 0.3 | 0.0 | 0.0 | | 0.0 | | 4 |
| ethanolamine | propenal | 23.1 | 11.9 | 4.5 | 2.0 | 0.9 | | | 5 |
| MBO | None | 19.1 | 16.8 | 13.3 | 9.3 | | 7.1 | 5.7 | 6 |
| MBO | Propenal | 16.4 | 0.0 | 0.0 | 0.0 | | 0.0 | | 7 |
| MEA triazine | Ethyl-2- | 23.5 | 0.4 | 0.4 | 0.4 | | 0.6 | | 8 |
| | chloroacetoacetate | | | | | | | | |
| NaOH | Propenal | 22.0 | 7.4 | 0.7 | 0.2 | | 0.1 | | 9 |

MBO is methylene bis(5-methyloxazolidine)

### EXAMPLE 5

A range of scavengers and scavenger combinations were contacted in excess amounts with an aqueous composition comprising hydrogen sulfide at different temperatures. The results are shown in table 5:

TABLE 5

| | Molar | H₂C | Solids remaining after | | |
|---|---|---|---|---|---|
| | ratio (to 1 | detected | scavenging: | | |
| Scavenger | eq H₂C | at end ? | at 30° C.? | at 80° C.? | at 180° C.? |
| MEA | 5 | yes | no | no | no |
| triazine | | | | | |
| MEA | 2 | yes | no | no | yes |
| triazine | | | | | |
| A | 5 | no | no | no | no |
| A | 2 | no | no | no | no |
| B | 5 | no | no | no | no |
| B | 2 | no | no | no | no |
| C | 5 | no | no | no | no |
| C | 2 | no | no | no | no |

Scavenger A contained 1 part MEA triazine and 2 parts maleimide.

Scavenger B contained 1 part MEA triazine and 4 parts maleimide.

Scavenger C contained 1 part MEA triazine and 2.7 parts ethyl-2-chloroacetoacetate.

1. A method of scavenging acid sulfide species from an industrial or environmental material, the method comprising contacting the material with:
(a) propenal and/or maleimide and/or ethyl-2-chloroacetoacetate; and
(b) a base.

2. The method according to claim 1 wherein component (a) comprises propenal and/or maleimide.

3. The method according to claim 1 wherein component (a) comprises propenal.

4. The method according to claim 1 wherein component (b) is selected from:
(i) amino compounds;
(ii) phosphorus containing bases; and
(iii) inorganic bases.

5. The method according to claim 1 wherein component (b) is selected from:
a triazine of formula (VA): 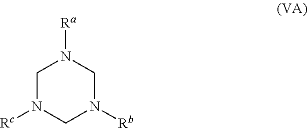
in which each of R^{a}, R^{b} and R^{c} is an alkyl, hydroxyalkyl or alkoxyalkyl group;
methylene bis(5-methyloxazolidine);
an amine of formula R¹R²R³N in which each of R¹, R² and R³ is independently hydrogen or an alkyl group which is optionally substituted with a group selected from hydroxy, alkoxy, amino, alkylamino, dialkylamino or aryl, provided that at least one of R¹, R² and R³ is not hydrogen;
a trialkyl phosphine; and
an alkali metal or ammonium hydroxide

6. The method according to claim 1 wherein component (b) comprises an amino compound selected from monoethanolamine triazine (MEA triazine), monomethylamine triazine (MMA triazine), methoxypropylamine triazine (MOPA triazine), methylene bis(5-methyloxazolidine), monoethanolamine, triethylamine, methoxypropylamine, cyclohexylamine, triethanolamine, 3-phenylpropylamine, diethanolamine, 2-aminopropylamine, tributylamine, N-(2-hydroxyethyl)ethylenediamine, N¹,N¹-bis(2-aminoethyl)-1,2-ethanediamine, 1-(2-aminoethyl)piperazine, 4-(2-aminoethyl)phenol, 2-amino-2-(hydroxymethyl)propane-1,3-diol, 4-(2-aminoethyl)morpholine, 2-(2-aminoethoxy)ethanol, dimethylaminopropylamine, ethylene diamine and 1,8-diazabicyclo(5.4.0)undec-7-ene (DBU).

7. The method according to claim 1 wherein component (a) is selected from MEA triazine, MMA triazine, MOPA triazine, monoethanolamine, methoxypropylamine, triethylamine, 2-aminoethoxyethanol, methylene bis(5-methyloxazolidine) and N-(2-hydroxyethyl) ethylene diamine.

8. The method according to claim 1 wherein component (a) is selected from monomethylamino triazine, monoethanolamine triazine and methoxypropylamine triazine.

9. The method according to claim 1 wherein component (a) and component (b) are added to the industrial or environmental material in a single composition or in separate compositions.

10. The method according to claim 9 wherein component (a) and component (b) are added to the industrial or environmental material in separate compositions.

11. The method according to claim 1 wherein the industrial or environmental material is selected from crude oil, produced water, petroleum refinery liquids, coke, asphalt or bitumen, used fracturing fluids, used water-flooding fluids, brines, geothermal fluids or sour gas.

12. The method according to claim 1 wherein the industrial or environmental material comprises water.

13. The method according to claim 1 wherein the acidic sulfide species is hydrogen sulfide.

14. A product for scavenging acid sulfide species, the product comprising:
(a) a first composition comprising propenal and/or maleimide and/or ethyl-2-chloroacetoacetate; and
(b) a second composition comprising a base.

15. The product according to claim 14 which further comprises (c) a scale inhibitor and/or a corrosion inhibitor.

16. The product according to claim 14 which further comprises one or more further components selected from biocides, friction reducers, drag reducing agents, surfactants, foaming agents, carbon dioxide scavengers, oxygen scavengers and metal scavengers

17. (canceled)

18. The product according to claim 14 wherein the first composition comprising propenal and/or maleimide and/or ethyl-2-chloroacetoacetate is an aqueous or organic composition.

19. The product according to claim 14 wherein the second composition comprising a base is an aqueous composition.

20. The product according to claim 14 which scavenges and retains hydrogen sulfide at temperatures in excess of 140° C.

21. (canceled)

22. The method according to claim 1 wherein the first composition comprising propenal and/or maleimide and/or ethyl-2-chloroacetoacetate is an aqueous or organic composition.

23. The method according to claim 1 wherein the second composition comprising a base is an aqueous composition.

24. The method according to claim 1 which scavenges and retains hydrogen sulfide at temperatures in excess of 140° C.
